(19) United States
(12) Patent Application Publication
(10) Pub. No.: US 2020/0384628 A1
(43) Pub. Date: Dec. 10, 2020

(54) Tower Gripz

(71) Applicants: Brandon Melanson, Myakka City, FL (US); Edward A. Manasse, Myakka City, FL (US); Bruce Melanson, Tampa, FL (US)

(72) Inventors: Brandon Melanson, Myakka City, FL (US); Edward A. Manasse, Myakka City, FL (US); Bruce Melanson, Tampa, FL (US)

(21) Appl. No.: 16/434,230

(22) Filed: Jun. 7, 2019

(51) Int. Cl. B25G 1/10; B25G 1/01; C09J 123/08; C09J 5/08

(52) U.S. Cl. CPC B25G 1/10; C09J 5/08; C09J 123/0853; B25G 1/01

(57) ABSTRACT

The present invention discloses an advanced system of handgrip apparatus including a hollow housing defining a handgrip surface and forming an enclosure and a rigid surface for the slip free holding of assembly. The shock dampening hand grip wraps around various diameters of raw stainless steel or powder coated railings commonly used on all types of recreational boats. When applied to a railing, grab bar, T-Top or ladder, the inner EVA (ethylene vinyl acetate) copolymer foam provides an adhesive surface which prevents the grip from sliding up or down or side to side. The present technology presents an ergonomic hand grip with a predetermined length to propose a superior support, vibration dampening and impact absorption, thereby reducing fatigue for the users' hand.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to an improved grip for recreational boats and is more particularly related to grips for hand operated assembly which are made from a reversible copolymer foam material that is designed for use without fatigue or pain in users' hand.

### Description of the Related Art

A common concern on recreational boat is a lack of places to grip hand to, especially while standing up. Most boat have railings or bars, but they are smooth on the surface and not suitable to provide a comfortable, secure grip. The shock dampening hand grip wraps around various diameters of raw stainless steel or powder coated railings commonly used on all types of recreational boats.

Thus, there is always a need assessed to provide an assembly which relates to an ergonomic hand grip with a predetermined length that provides superior support, vibration dampening and impact absorption, thereby reducing fatigue for the user.

It has to be noted that the current invention proposes an advancement in providing a hand support in the recreational boats. The current invention aims to ensure a safe and comfortable assembly which presents shock dampening hand grip wraps around various diameters of raw stainless steel or powder coated railings commonly used on all types of recreational boats. When the proposed assembly is applied to a railing, grab bar, T-Top or ladder, the inner EVA (ethylene vinyl acetate) copolymer foam provides for an adhesive surface which prevents the grip from sliding up or down or side to side. Furthermore, the grip has a slit down the middle to wrap around the said applications and the slit is secured at the top and bottom with any locking device with a diameter less than 0.31″, typical securing devices include D-ring, carabiner or zip tie. The outer grip portion has rectangular fillets from top to bottom that conform to the user's hand and provides a feeling of tackiness which prevents users hand from sliding off the grip. The grip is designed in three different diameters to account for the various railing sizes used on recreational boats. The EVA foam, due to its inherent characteristics, is UV resistant and chemical, oil, and fuel spill/splash resistant making it the ideal material for the boating industry and specifically this technology.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of an ergonomic hand grip with a predetermined length that provides superior support, vibration dampening and impact absorption, thereby reducing fatigue for the user.

It is another objective of the invention to provide a safe and comfortable assembly which presents shock dampening hand grip wraps around various diameters of raw stainless steel or powder coated railings commonly used on all types of recreational boats.

It is further the objective of the invention to provide an inner EVA (ethylene vinyl acetate) copolymer foam for an adhesive surface to prevent the grip from sliding up or down or side to side.

It is also the objective of the invention to provide an outer grip portion which has rectangular fillets from top to bottom to allow the user's hand having a firm support and provide a feeling of tackiness which prevents users hand from sliding off the grip.

It is another objective of the invention to provide a grip which is designed in three different diameters to account for the various railing sizes used on recreational boats. [0012] It is further the object of the invention to provide a handgrip specifically made for recreational boats where the EVA foam, proposes a UV resistant and chemical, oil, and fuel spill/splash resistant making it the ideal material for the boating industry.

A further object is to provide an assembly that is simple and easy to use.

It is a further object of the present invention to provide a new and improved assembly which is reliable and long term to use in marine environment.

Still yet another object of the present invention is to provide a new and improved holding support specifically for recreational boats, which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

One aspect of the present application is directed to provide an ergonomic hand grip with a predetermined length that provides superior support, vibration dampening and impact absorption, thereby reducing fatigue for the user

The current invention aims to ensure a safe and comfortable assembly which presents shock dampening hand grip wraps around various diameters of raw stainless steel or powder coated railings commonly used on all types of recreational boats. The proposed assembly is applied to a railing, grab bar, T-Top or ladder, the inner EVA (ethylene vinyl acetate) copolymer foam provides for an adhesive surface, which prevents the grip from sliding up or down or side to side.

The grip as per its further embodiment presents a grip which has a slit down the middle to wrap around the said applications and the slit is secured at the top and bottom with any locking device with a diameter less than 0.31″, typical securing devices include D-ring, carabiner or zip tie.

The outer grip portion as per its additional embodiment has rectangular fillets from top to bottom that conform to the user's hand and provides a feeling of tackiness which prevents users hand from sliding off the grip.

The hand grip as per its additional embodiment is designed in three different diameters to account for the various railing sizes used on recreational boats. The EVA foam, due to its inherent characteristics, presents a UV resistant and chemical, oil, and fuel spill/splash resistant making it the ideal material for the boating industry and specifically this technology.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is an illustration of front view of the assembly as per exemplary embodiments of the invention.

FIG. 2 is also a complete view consistent with the exemplary embodiments of the present invention.

FIG. 3 is cross sectional view showing the inner dimensions, consistent with the exemplary embodiments of the present invention.

FIG. 4 is another view of proposed assembly, consistent with the exemplary embodiments of the present invention.

FIG. 5 is a perspective view of our Invention.

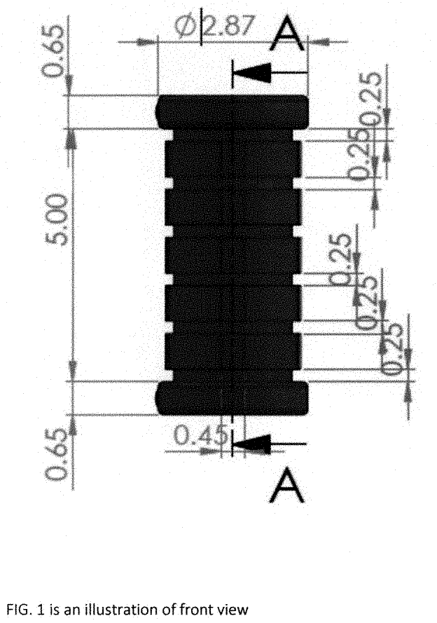

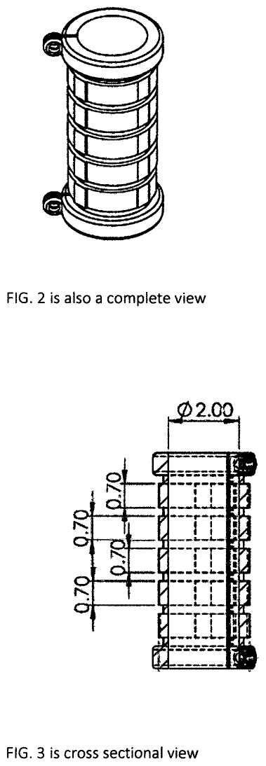

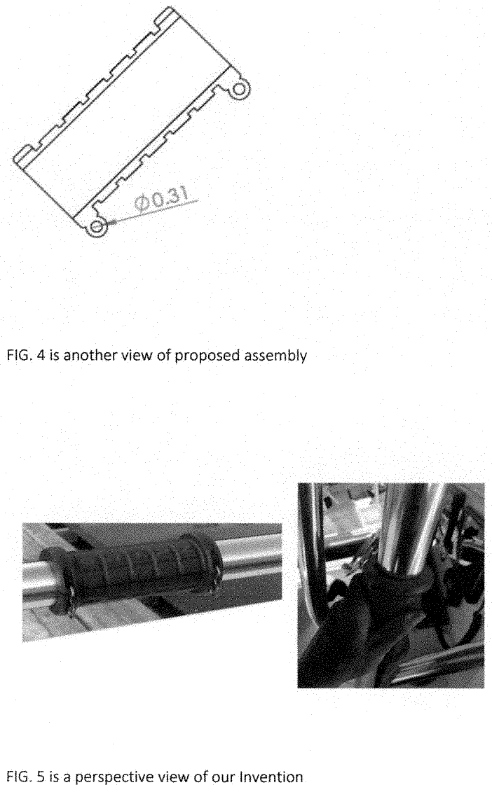

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

I. A hand grip with a predetermined length where:
a shock dampening hand grip wraps around various diameters of raw stainless steel or powder coated railings;
an inner EVA (ethylene vinyl acetate) copolymer foam;
a grip having a slit down the middle to wrap around the assembly;
a slit secured at the top and bottom with any locking device with a diameter less than 0.31 inches;
a typical securing device including D-ring, carabiner or zip;
an outer grip portion having a rectangular fillet from top to bottom that conform to the user's hand.

II: A gripping device specifically focused on providing support on recreational boats where the grip is designed in three different diameters to account for the various railing sizes used on recreational boats.

III: A gripping device with EVA foam, which, is UV resistant, chemical, oil, and fuel spill or splash resistant making it the ideal material for the boating industry and specifically this technology.
